(19) United States
(12) Patent Application Publication
(10) Pub. No.: US 2005/0210496 A1
(43) Pub. Date: Sep. 22, 2005

(54) Disc cartridge

(75) Inventor: Kengo Oishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/083,977

(22) Filed: Mar. 21, 2005

(30) Foreign Application Priority Data
Mar. 19, 2004 (JP) 2004-080079

(51) Int. Cl. G11B 23/03

(52) U.S. Cl. 720/739

(57) ABSTRACT

A head aperture portion, for access to a recording surface of a disc medium which is rotatably accommodated in a case, is opened and closed by a first shutter, which rotates coaxially with the disc medium, and a second shutter, which moves around a different axis from the first shutter. In a closed state, a first protrusion portion and a second protrusion portion, which are respectively formed in circular arc shapes, constitute an annular shape and abut at an inner side of the disc medium recording surface, thus blocking ingression of dust to the recording surface. During opening/closing and in a closed state of the head aperture portion, a guide mechanism, which is structured by a cam portion and a sliding protrusion, moves the second shutter away from the disc medium. Consequently, the second protrusion portion can be reliably prevented from interfering with the recording surface of the disc medium.

### CROSS-REFERENCE TO RELATED APPLICATION

This application claims priority under 35 USC 119 from Japanese patent application, No. 2004-80079, the disclosure of which is incorporated by reference herein.

### BACKGROUND OF THE INVENTION

1. Field of the Invention

The present invention relates to a disc cartridge which rotatably accommodates, in a case, a circular plate-form disc medium which is employed as a medium for recording/replaying of data, images, etc.

2. Description of the Related Art

Circular plate-form disc media, such as optical discs, magneto-optical discs and the like, are employed as, for example, recording/playback media for computers, image recording/playback media and so forth.

When recording or playback of such a disc medium is to be performed, the disc medium, having been loaded at a disc drive device, is rotated by a spindle shaft. At the same time, laser light, or laser light together with a magnetic field, is irradiated at a recording layer of the disc medium by a recording head which accesses a recording surface side of the disc medium.

Accordingly, recording of information is implemented at the disc medium by pit formation, phase conversion, magnetic inversion or the like resulting from decomposition and/or heating of the recording layer. Alternatively, playback of recorded information is carried out by detecting, with a playback head, reflection rates, polarization angles or the like of laser light that has been irradiated from the playback head.

In accordance with increases in recording capacities of such disc media, disc cartridges which accommodate a disc medium in an accommodation region of a case in order to prevent the adherence of dust and the like to the face of a recording surface side of the disc medium (i.e., a cover layer which covers a recording layer) have become known (see, for example, Japanese Patent Application Laid-Open (JP-A) No. 2003-115184).

At such a disc cartridge, a chucking aperture portion and a head aperture portion are formed in the case at the recording surface side of the disc medium, for enabling access to a center hole and the recording surface side of the disc medium. These apertures are opened and closed by a pair of shutters, which are driven by an inner rotor.

Further, disc cartridges at which an aperture portion, for enabling removal and insertion of the disc medium, is provided at a side of a case which is opposite to a side thereof at which a chucking aperture portion and head aperture portion are provided are known (see, for example, JP-A No. 2003-242740). When this aperture portion is provided and the pair of shutters, including the inner rotor, are operated in a common plane, it is possible to make the disc cartridge thinner. Such a disc cartridge will be described with reference to FIGS. 12A and 12B.

At a disc cartridge 100 shown in FIGS. 12A and 12B, a chucking aperture portion 104 and a head aperture portion 106 are both formed in a bottom plate 102A of a case 102. The chucking aperture portion 104 is for accessing a center hole of a disc medium (not shown), and the head aperture portion 106 is for allowing a head of a drive device to access a recording surface. A first shutter 108 and a second shutter 110 are provided in the case 102 between the disc medium and the bottom plate 102A. The first shutter 108 is rotatably supported coaxially with the disc medium, and the second shutter 110 has a rotation shaft 112 at an outer side of the case 102 in a radial direction of the disc medium.

The first shutter 108 and the second shutter 110 fit together at abutting end faces 108A and 110A thereof, which are ends which fit together with one another as shown in FIG. 12A. Thus, the first shutter 108 and the second shutter 110 close off the head aperture portion 106 while maintaining the chucking aperture portion 104 in a constantly open state. Then, when the first shutter 108 turns in the direction of arrow G and the second shutter 110 turns in the direction of arrow H, which is substantially opposite to arrow G, with respect to the head aperture portion 106, the head aperture portion 106 is opened up as shown in FIG. 12B.

The first shutter 108 and second shutter 110 are interlockingly operated. Specifically, a protrusion 114, which protrudes from the first shutter 108, is inserted into a guide slot 116 which is formed in the second shutter 110. When the first shutter 108 turns in the direction of arrow G, the protrusion 114 slides against a slot wall of the guide slot 116 and pushes the slot wall. Thus, the second shutter 110 turns in the direction of arrow H, and the head aperture portion 106 is opened up. Further, the head aperture portion 106 is closed off by an opposite operation.

Inner periphery-holding protrusion portions 118 and 120, which are formed in circular arc forms in plan view, are provided protruding from an upper face of the first shutter 108 and an upper face of the second shutter 110, respectively. Circumferential direction end portions of this pair of inner periphery-holding protrusion portions 118 and 120 are abutted against one another in the state in which the head aperture portion 106 is closed. As a whole, the inner periphery-holding protrusion portions 118 and 120 form an annular shape which encircles the chucking aperture portion 104 in plan view. A surface of the disc medium around a center hole provided at a central portion of the disc medium abuts against upper end faces of the inner periphery-holding protrusion portions 118 and 120 that form this annular shape.

As a result, ingression of dust or the like through the chucking aperture portion 104 to the recording surface of the disc medium is blocked. Further, an outer periphery-holding protrusion portion 122 is provided at an outer peripheral portion of the first shutter 108. The outer periphery-holding protrusion portion 122 abuts against a region at a radial direction outer side relative to the recording surface of the disc medium. Thus, ingression of dust or the like to the recording surface side from an outer periphery side of the disc medium is blocked.

Further, in the disc cartridge 100, in a state in which the head aperture portion 106 is fully opened or closed, the protrusion 114 of the first shutter 108 enters into a groove (not shown) in the bottom plate 102A.

Hence, in a process of opening or closing the head aperture portion 106, the protrusion 114 comes out of this groove and slides against the bottom plate 102A. As a result, a portion of the first shutter 108 at the protrusion 114 side thereof is lifted up, and interference between the inner periphery-holding protrusion portion 120 provided at the second shutter 110 and the recording surface of the disc medium is prevented.

In the state in which the head aperture portion 106 is fully opened, the protrusion 114 enters into the groove, the first shutter 108 subsides, and the disc medium returns to a state of being level with respect to the bottom plate 102A. As a result, retention of the disc medium by a rotating spindle shaft of a drive device is enabled.

However, in the conventional disc cartridge 100 as described above, when the first shutter 108 subsides in the state in which the head aperture portion 106 is fully opened, a height of the inner periphery-holding protrusion portion 120 coincides with a height of the inner periphery-holding protrusion portion 118. Therefore, there is a risk that the recording surface of the disc medium may come into contact with the inner periphery-holding protrusion portion 120 before retention and lifting by the rotating spindle shaft. Such contact between the inner periphery-holding protrusion portion 120 and the recording surface is a source of damage to the recording surface.

A structure capable of preventing contact between the inner periphery-holding protrusion portion 120 and the recording surface in the state in which the head aperture portion 106 has been completely opened is described in the aforementioned JP-A No. 2003-242740. However, this structure tilts the disc medium with respect to the bottom plate 102A before any retention by the rotating spindle. Thus, it is difficult for the rotating spindle shaft to retain the disc medium in an accurately positioned state. Therefore, this structure is not practical.

In consideration of the circumstances described above, an object of the present invention is to provide a disc cartridge which is capable of reliably preventing a second protrusion portion from interfering with a recording surface of a disc medium, which second protrusion portion is provided at a second shutter for dustproofing and for supporting a vicinity of the disc medium at an inner side of the recording surface.

### SUMMARY OF THE INVENTION

In order to achieve the object described above, in a first aspect of the present invention, a disc cartridge includes: a case rotatably accommodating a circular plate-form disc medium, the case including a head aperture portion for enabling access to a recording surface of the disc medium; a first shutter provided in the case at the recording surface side of the disc medium, the first shutter turning coaxially with an axial center of the disc medium for opening and closing a portion of the head aperture portion; a second shutter provided in the case at the recording surface side of the disc medium to be movable toward and away from the disc medium, the second shutter turning about a different axis from the first shutter for opening and closing a remaining portion of the head aperture portion; a first protrusion portion provided at the first shutter and formed in a circular arc shape, the first protrusion portion abutting against the disc medium at an inner side relative to the recording surface; a second protrusion portion provided at the second shutter and formed in a circular arc shape, the second protrusion portion and the first aperture portion provided at the first shutter together forming an annular shape in a state in which the head aperture portion is closed; and a guide mechanism which, in the state in which the head aperture portion is closed, retains the second shutter at a position near to the disc medium, at which near position the second protrusion portion, together with the first protrusion portion, abuts against the disc medium at the inner side relative to the recording surface, and which, in processes of opening and closing the head aperture portion and in a state in which the head aperture portion is opened, displaces the second shutter to be separated further from the disc medium than the near position.

At a disc cartridge based on the present aspect, the head aperture portion for access to the recording surface of the disc medium accommodated in the case is closed off by the first shutter and the second shutter at times of non-use. At times of use, the first shutter and the second shutter are respectively turned about rotation axes thereof to open up the head aperture portion.

In the state in which the head aperture portion has been opened up (that is, during use), the disc medium is driven to rotate by a drive device, and a head of the drive device gains access to the recording surface through the head aperture portion and implements recording of information and/or playback of recorded information. That is, the case accommodates the disc medium to be relatively rotatable such that rotary driving of the disc medium by the drive device is possible.

Further, in the state in which the first shutter and the second shutter have completely closed off the head aperture portion, the first protrusion portion of the first shutter and the second protrusion portion of the second shutter, which is retained by the guide mechanism at the position near to the recording surface of the disc medium, constitute the annular shape and are respectively abutted at a region at a radial direction inner side relative to the recording surface of the disc medium.

Consequently, ingression of dust and the like to the recording surface side of the disc medium is blocked by the first protrusion portion and the second protrusion portion, even in, for example, a structure in which a chucking aperture portion is not closed off.

Here, during a process in which the first shutter and the second shutter are opening or closing the head aperture portion and in the state in which the head aperture portion has been fully opened, the second shutter is disposed at a position which is separated further from the disc medium than the above-mentioned near position. Consequently, the second protrusion portion provided at the second shutter is prevented from making contact with the recording surface of the disc medium.

In the state in which the head aperture portion is open, the disc medium abuts against the first protrusion portion of the first shutter (and other portions which do not interfere with the recording surface of the disc medium) and is maintained in a state of being substantially level with respect to the case. As a result, retention of the disc medium by a rotating spindle shaft of a drive device can be performed with accuracy and ease.

Thus, in a disc cartridge based on the present aspect, the second protrusion portion, which is provided at the second shutter for dustproofing and for supporting a vicinity of the disc medium at the inner side of the recording surface, can be reliably prevented from interfering with the recording surface of the disc medium.

Herein, the guide mechanism is provided, for example, between the first shutter and the second shutter or between the case and the second shutter. Furthermore, a force that moves the second shutter relatively away from the disc medium may be provided by, for example, gravity, a force that turns the second shutter or the first shutter, an urging force from a resilient member, or the like.

In a second aspect of the present invention, the case includes a support shaft provided at a radial direction outer side relative to the disc medium, the second shutter includes a boss portion which is fitted to the support shaft, the second shutter being supported to be rotatable with respect to the support shaft and movable in an axial direction of the support shaft, and the guide mechanism is provided between the boss portion and a portion of the case around the support shaft.

In a disc cartridge based on the present aspect, the support shaft, which is at the axis of rotation of the second shutter, is disposed at the radial direction outer side of the disc medium, and the guide mechanism is provided between the portion of the case around this support shaft and the boss portion of the second shutter. Therefore, the guide mechanism, which moves the second shutter relatively away from the disc medium, is disposed at the radial direction outer side of the disc medium and is provided to efficiently utilize limited space inside the case.

In a third aspect of the present invention, the guide mechanism of the second aspect described above includes: a cam portion, which is provided at the case around a base portion of the support shaft and forms a taper-form step in a circumferential direction of the support shaft; and a follower, which is provided protruding from the support shaft base portion side of the boss portion and which slides against a cam surface in accordance with opening and closing of the head aperture portion.

In a disc cartridge based on the present aspect, when the second shutter turns about the support shaft in the direction for closing the head aperture portion, the follower slides against the cam portion. The follower rides up on the taper-form step of the cam portion until the second shutter reaches a position at which the head aperture portion is closed, and the second protrusion portion abuts against the surface of the disc medium around a center hole. When the second shutter turns in the direction for opening the head aperture portion from this state, the follower slides against the cam portion including the step while the second shutter moves in the direction of separation from the recording surface of the disc medium and the second protrusion portion moves away from the recording surface. Thus, the guide mechanism is constituted by a simple structure.

In a fourth aspect of the present invention, a disc cartridge based on any of the first to third aspects described above further includes an urging member which urges the second shutter in a direction away from the disc medium.

In a disc cartridge based on the present aspect, the urging member urges the second shutter in the direction of separation from the recording surface of the disc medium. Therefore, during processes of opening and closing the head aperture portion and when the head aperture portion is opened, that is, in states in which retention at the near position by the guide mechanism is released, the second shutter (the second protrusion portion) is reliably separated from the recording surface of the disc medium. Furthermore, operation of the second shutter, which is movable toward and away from the disc medium (i.e., movable in an axial direction) is stable.

Further, even at, for example, a vertical-type drive device in which the rotation axis of the disc medium is aligned with a horizontal plane, the second shutter, specifically the second protrusion portion, is reliably separated from the recording surface of the disc medium in the processes of opening and closing the head aperture portion and in the opened state.

In a fifth aspect of the present invention, a disc cartridge based on any of the first to fourth aspects described above further includes a stopper which limits movement of the second shutter such that the second protrusion portion does not protrude further toward the recording surface of the disc medium than the first protrusion portion.

In a disc cartridge based on the present aspect, the stopper is provided for limiting movement of the second shutter such that the second protrusion portion will not protrude further than the first protrusion portion. Consequently, there is no risk of the second shutter, which is moveable toward and away from the disc medium, damaging the disc medium in the state in which the head aperture portion is closed. Thus, even if, for example, the second shutter is pushed to the case interior side thereof due to carelessness by a user, damage to the disc medium is prevented.

In conclusion, with a disc cartridge relating to the present invention, an excellent effect is provided in that a second protrusion portion, which is provided at a second shutter for dustproofing and for support of a vicinity of a disc medium at an inner side of a recording surface, can be reliably prevented from interfering with the recording surface of the disc medium.

### BRIEF DESCRIPTION OF THE DRAWINGS

FIG. 1 is a perspective view showing the external appearance of a disc cartridge relating to an embodiment of the present invention.

FIG. 2 is an exploded perspective view of the disc cartridge relating to the embodiment of the present invention.

FIG. 3A is a schematic sectional view showing the disc cartridge relating to the embodiment of the present invention in a state in which a head aperture portion is closed.

FIG. 3B is a schematic sectional view showing the disc cartridge relating to the embodiment of the present invention in a state in which the head aperture portion is opened.

FIG. 4 is an exploded perspective view of a second shutter-raising/lowering mechanism which structures the disc cartridge relating to the embodiment of the present invention.

FIG. 5 is a perspective view, seen from below, of a second shutter which structures the disc cartridge relating to the embodiment of the present invention.

FIG. 6 is a schematic bottom view showing dust protection ribs which structure the disc cartridge relating to the embodiment of the present invention in the state in which the head aperture portion is closed.

FIG. 7 is a schematic bottom view showing the dust protection ribs which structure the disc cartridge relating to the embodiment of the present invention in the state in which the head aperture portion is opened.

FIG. 8 is a schematic plan view showing the state in which the head aperture portion is closed by a shutter mechanism which structures the disc cartridge relating to the embodiment of the present invention.

FIG. 9 is a schematic plan view showing a process of closing or opening of the head aperture portion by the shutter mechanism which structures the disc cartridge relating to the embodiment of the present invention.

FIG. 10 is a schematic plan view showing a different state from FIG. 9 in the process of closing or opening of the head aperture portion by the shutter mechanism which structures the disc cartridge relating to the embodiment of the present invention.

FIG. 11 is a schematic plan view showing the state in which the head aperture portion is opened by the shutter mechanism which structures the disc cartridge relating to the embodiment of the present invention.

FIG. 12A is a view showing a conventional disc cartridge in a state in which a head aperture portion has been closed by a shutter mechanism.

FIG. 12B is a view showing the conventional disc cartridge in a state in which the head aperture portion has been opened by the shutter mechanism.

### DETAILED DESCRIPTION OF THE INVENTION

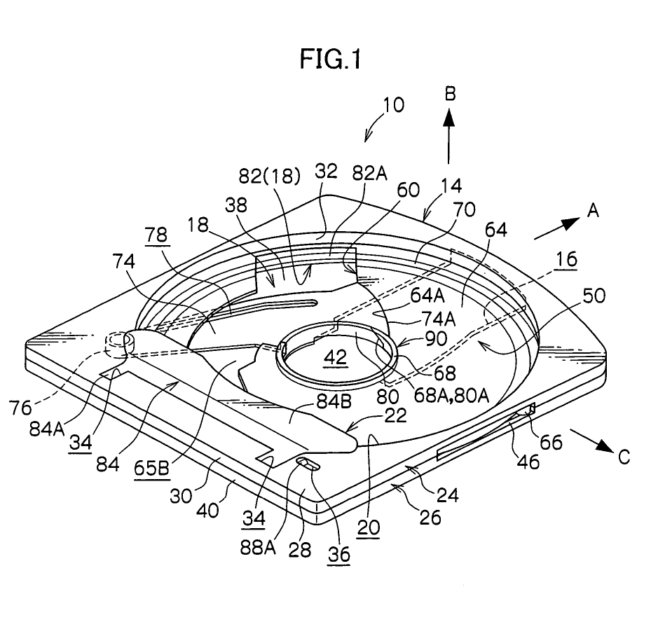

A disc cartridge 10 relating to an embodiment of the present invention will be described with reference to FIGS. 1 to 11. Note that an arrow A, which is shown when appropriate in the drawings, indicates a direction of loading of the disc cartridge 10 into a drive device and, for the sake of convenience, a side indicated by arrow A, which is the direction of loading into the drive device, is described as a front side. Further, a direction indicated by an arrow B is an upper side and a direction indicated by an arrow C is a right side.

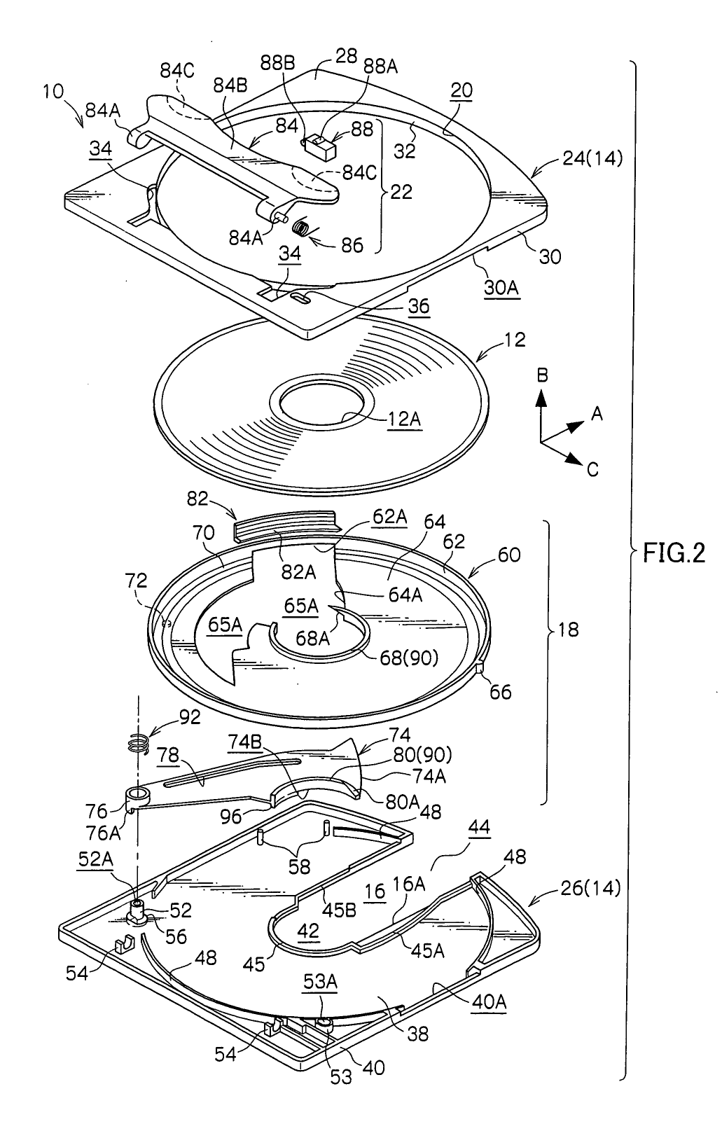

FIG. 1 shows an external form of the disc cartridge 10 in a perspective view, and FIG. 2 shows the disc cartridge 10 in an exploded perspective view.

As shown in FIGS. 1 and 2, the disc cartridge 10 is structured with a case 14, a shutter mechanism 18 and a disc retention mechanism 22 as principal structural components thereof. The case 14 rotatably accommodates a disc medium 12, which is formed in a circular plate shape and serves as an information recording/playback medium. The shutter mechanism 18 opens and closes a head aperture portion 16, which opens at a lower face of the case 14 for a recording/playback head to gain access to a recording surface of the disc medium 12. The disc retention mechanism 22 is for preventing the disc medium 12 from falling out through a disc aperture portion 20. The disc aperture portion 20 opens at the upper side of the case 14 for enabling removal and insertion of the disc medium 12 at the case 14.

Note that the disc medium 12 is omitted from the illustration in FIG. 1.

First, general overall structure of the disc cartridge 10 will be described. Thereafter, a second shutter-raising/lowering mechanism, which is a principal portion of the present invention, will be described.

Overall Structure of Disc Cartridge

Structure of Disc Medium

The disc medium 12 which is accommodated in the disc cartridge 10 is, as mentioned above, formed in a circular plate shape. A center hole 12A is formed at an axial center portion of the disc medium 12. The center hole 12A is chucked (engaged and retained) by a rotating spindle shaft of a disc drive device.

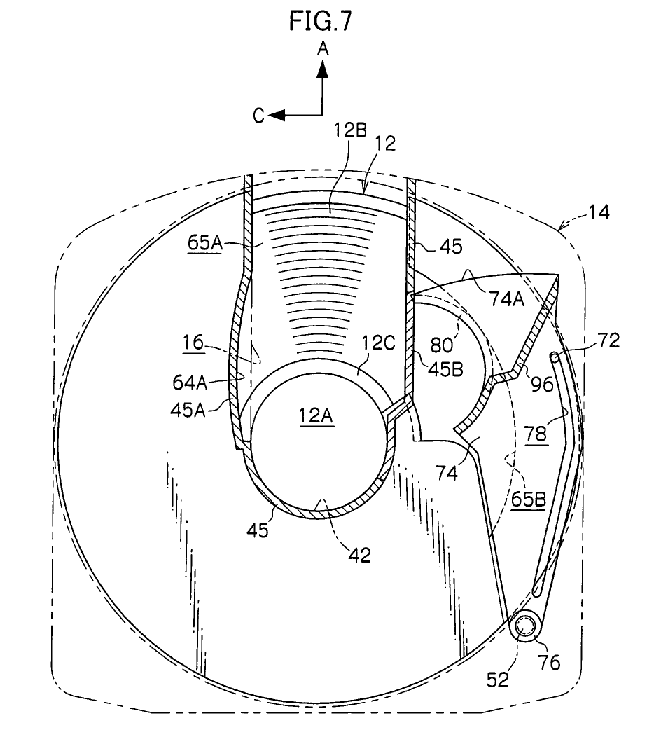

As shown in FIG. 7, a region of a lower face of the disc medium 12, which excludes predetermined ranges in a vicinity of an outer periphery and around the center hole 12A, serves as a recording surface (recording region) 12B, which is formed by protectively covering a recording layer with a cover layer.

A region of the lower face of the disc medium 12 between a hole edge of the center hole 12A and an inner edge of the recording surface 12B serves as a chucking area 12C, for the rotating spindle shaft of the drive device to retain the disc medium 12. In the present embodiment, a diameter (i.e., an external diameter) of the disc medium 12 is set to approximately 120 mm.

Structure of Case

The case 14 is structured in a flat box shape, which is substantially rectangular in plan view, by joining together an upper shell 24 and a lower shell 26. More specifically, in plan view, a front edge portion of the case 14 is formed in a circular arc form which is substantially symmetrical between left and right, and a rear edge of the case 14 is formed in a straight line form along the left-right direction. With such a shape, erroneous loading into a drive device can be avoided.

The upper shell 24 is provided with a ceiling plate 28 and an outer peripheral wall 30. The ceiling plate 28 has a shape which corresponds to the shape of the case 14 in plan view, and the outer peripheral wall 30 is provided standing downward substantially along an outer edge of the ceiling plate 28. The disc aperture portion 20, which is substantially circular in plan view, is formed in the ceiling plate 28. An internal diameter of the disc aperture portion 20 is larger than the external diameter of the disc medium 12. Thus, it is possible for the disc medium 12 to be inserted and removed (installed and uninstalled) through the disc aperture portion 20.

The upper shell 24 is also provided with an inner peripheral wall 32, which is provided standing downward along an edge portion of the disc aperture portion 20.

Cutaway portions 34 are formed at two locations of a radial direction outer side of the inner peripheral wall 32, at a rear end side of the ceiling plate 28. The cutaway portions 34 are for attachment of a disc-constraining member 84, which will be described later. Further, a lock operation window 36 is provided at a right side of the cutaway portion 34 that is at the right side of the ceiling plate 28. The lock operation window 36 has a long dimension in the left-right direction, and is for operation of a locking member 88, which will be described later.

A cutaway portion 30A is formed in the outer peripheral wall 30, at a front-rear direction central portion of a portion of the outer peripheral wall 30 that structures a side wall at the right side of the case 14. An edge portion of the cutaway portion 30A has a ‘II’-like shape which opens downward and is formed to be long in the front-rear direction.

The lower shell 26 is provided with a floor plate 38 and an outer peripheral wall 40. The floor plate 38 has a shape substantially corresponding with the ceiling plate 28, and the outer peripheral wall 40 has a shape substantially corresponding with the outer peripheral wall 30. A substantially circular chucking aperture portion 42, which corresponds with the center hole 12A of the disc medium 12, and the aforementioned head aperture portion 16 are formed in the floor plate 38. In the following descriptions, the chucking aperture portion 42 and the head aperture portion 16 will sometimes be referred to together as an access aperture 44.

The head aperture portion 16 is formed in a substantially rectangular form, which is long in a radial direction of the chucking aperture portion 42, and is communicated with a front side of the chucking aperture portion 42. Accordingly, an incision edge of the floor plate 38 that forms the access aperture 44 is formed in a substantial ‘U’ shape which opens toward the front. The head aperture portion 16 is further structured by cutting away a left-right direction central portion of a front portion of the outer peripheral wall 40, along the whole height thereof.

A case-side dust protection rib 45 is provided protruding from an upper face of the floor plate 38. The case-side dust protection rib 45 will be described later, together with the second shutter-raising/lowering mechanism.

An upper end (opening end) of the outer peripheral wall 40 is matched up with a lower end (opening end) of the outer peripheral wall 30 of the upper shell 24, so as to structure a peripheral wall of the case 14. A cutaway portion 40A is formed at a position of this outer peripheral wall 40 which corresponds with the cutaway portion 30A of the upper shell 24. An edge portion of the 40A has a ‘II’ shape which opens upward and is formed to be long in the front-rear direction.

In the state in which the opening ends of the outer peripheral wall 30 and the outer peripheral wall 40 are matched up with one another, the cutaway portion 30A and the 40A form a shutter operation window 46 in a side face at the right side of the case 14 (see FIG. 1). The shutter operation window 46 is provided for exposure of an operation protrusion 66 of an inner rotor 60, which will be described later.

The lower shell 26 is also provided with an inner wall 48, which is provided standing from the floor plate 38 along portions of a circular circumference which is concentric with the chucking aperture portion 42. An inner diameter of a notional circle linking inner face portions of the inner wall 48 is set to be slightly larger than an outer diameter of the inner peripheral wall 32 of the upper shell 24. Thus, in the state in which the upper shell 24 and the lower shell 26 are joined together, a gap is formed between the inner wall 48 and the inner peripheral wall 32. At this structure, an annular wall portion 62 (to be described later) of the inner rotor 60 is inserted into this gap.

The floor plate 38, the inner wall 48 and the inner peripheral wall 32 of the upper shell 24 form a disc accommodation portion 50 (see FIG. 1), which serves as an accommodation portion for accommodating the disc medium 12 inside the case 14. The disc medium 12 can be inserted and removed at the disc accommodation portion 50 through the disc aperture portion 20 as mentioned above.

A support shaft 52 is provided protruding from a vicinity of a rear-left corner portion of the floor plate 38. An axial center of the support shaft 52 is located at an outer side of a circumference along an outer face of the inner wall 48, that is, at an outer side of the disc accommodation portion 50. In the present embodiment, the support shaft 52 is formed in a cylindrical shape with a reference hole 52A formed thereinside. The reference hole 52A is opened to an outer face of the floor plate 38.

A protrusion 53 is provided from a vicinity of a rear-right corner portion of the floor plate 38. A reference hole 53A, which is long in the left-right direction, is provided at the protrusion 53 to form a pair with the reference hole 52A. A pair of left and right bearing portions 54 is provided protruding from a rear portion of the floor plate 38, at the radial direction outer side of the inner wall 48. The bearing portions 54 are provided for supporting shafts of the disc-constraining member 84. A cam portion 56 is provided at the floor plate 38, protruding from a base portion of the support shaft 52. The cam portion 56 will be described later.

Further still, a pair of guide pins 58 is provided protruding at a vicinity of a front-left corner portion of the floor plate 38. The pair of guide pins 58 is disposed on an imaginary circular circumference which is concentric with the inner wall 48 and has a larger diameter than the inner wall 48. The guide pins 58 are for guidance of a disc-holding member 82, which will be described later.

In the state in which an upper end face of the outer peripheral wall 40 is matched up with a lower end face of the outer peripheral wall 30, the lower shell 26 described above is joined together with the upper shell 24, by fixing with screws, to structure the case 14. Here, instead of screw-fixing, the upper shell 24 and lower shell 26 may be joined together by, for example, ultrasonic welding, adhesion or the like of the outer peripheral walls 30 and 40.

Structure of Shutter Mechanism

The shutter mechanism 18 is provided in the case 14. Specifically, the shutter mechanism 18 is equipped with the inner rotor 60, which is disposed inside the case 14. The inner rotor 60 is provided with the annular wall portion 62, which is formed in a short tubular shape. As mentioned above, the annular wall portion 62 slidably fits into the gap between the inner peripheral wall 32 of the upper shell 24 and the inner wall 48 of the lower shell 26. Thus, the inner rotor 60 is made rotatable with respect to the case 14, coaxially with the disc accommodation portion 50 (and the disc medium 12 accommodated therein).

A flat plate-form first shutter 64 is provided integrally at the inner side of a lower end of the annular wall portion 62. The first shutter 64 has the form of a circular plate which is concentric with and has the same diameter as the annular wall portion 62 and which features a cutaway portion 65A and a cutaway portion 65B. The cutaway portion 65A has substantially the same shape as the access aperture 44, and the cutaway portion 65B corresponds to a path of relative movement of a second protrusion portion 80 a circular arc rib) of a second shutter 74, which will be described later.

Further, a cutaway portion 62A is formed in the annular wall portion 62. The cutaway portion 62A communicates with a radial direction outer end of the cutaway portion 65A, and a shape of an edge portion of the cutaway portion 62A is a substantial ‘II’ shape which opens downward. When this cutaway portion 62A coincides with a cut away portion of the outer peripheral wall 40 of the lower shell 26, a structure which allows a recording/playback head to gain access from frontward of the disc cartridge 10 is formed.

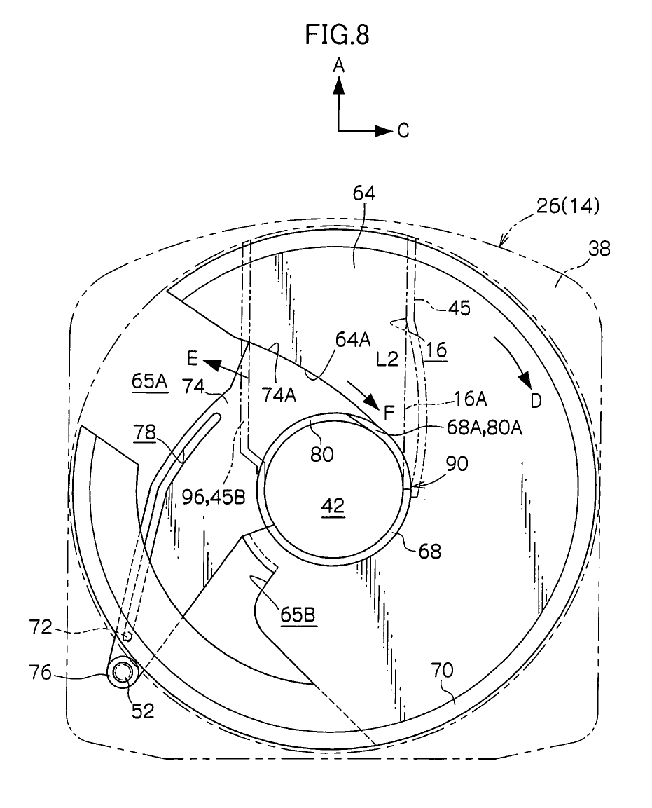

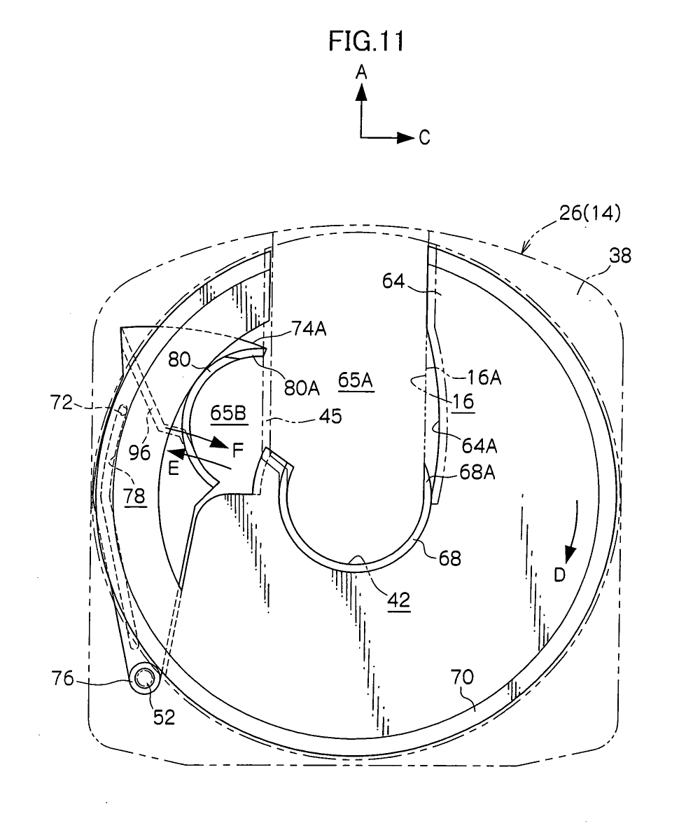

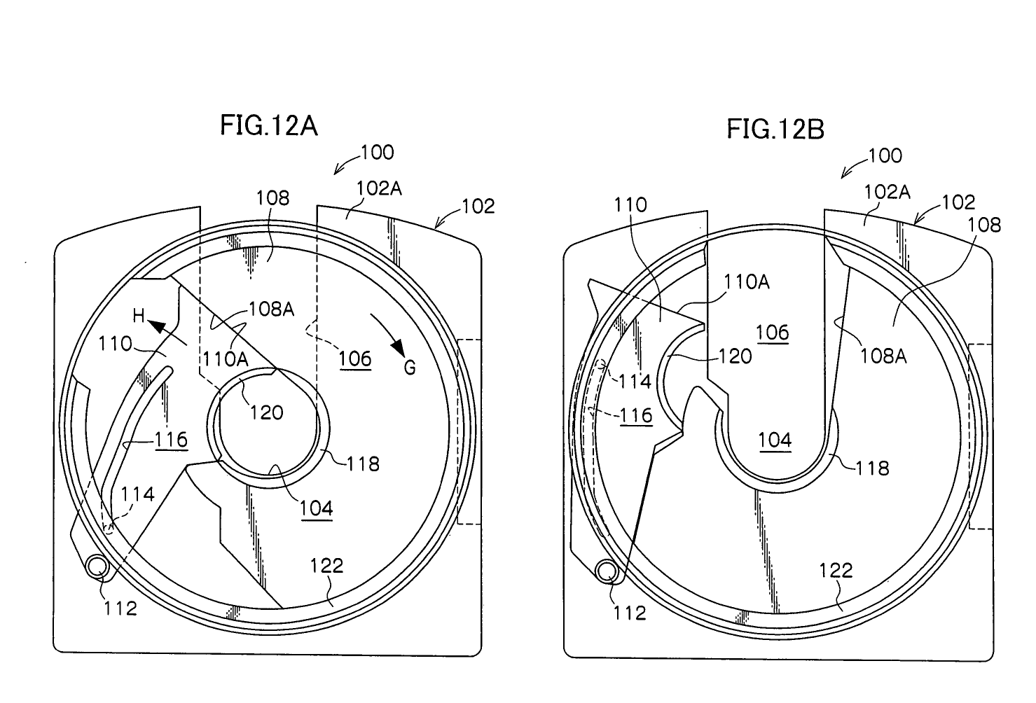

The first shutter 64 is slidably rested on the floor plate 38 of the lower shell 26 (i.e., the disc accommodation portion 50). In accordance with rotation of the inner rotor 60, the first shutter 64 can attain a closed position (see FIG. 8), at which the first shutter 64 closes off an outer peripheral side and some of an inner peripheral side of the head aperture portion 16, and an opened position (see FIG. 11), at which the first shutter 64 is withdrawn from the head aperture portion 16. That is, when the first shutter 64 is disposed at the opened position, the cutaway portion 65A thereof is disposed to substantially coincide with the access aperture 44.

The operation protrusion 66 is provided protruding from an outer periphery face of the annular wall portion 62. The operation protrusion 66 is exposed through the shutter operation window 46 to the exterior of the case 14. The operation protrusion 66 is provided so as to be disposed at a front end of the shutter operation window 46 when the first shutter 64 is disposed at the closed position and so as to be disposed at a rear end of the shutter operation window 46 when the first shutter 64 is disposed at the opened position.

A first protrusion portion 68 is provided standing from an upper face of the first shutter 64. The first protrusion portion 68 is formed in a circular arc shape along an edge portion of the cutaway portion 65A that corresponds with the chucking aperture portion 42. The first protrusion portion 68, together with the later-described second protrusion portion 80, constitutes an annular disc inner periphery-holding portion 90. An upper end face of this disc inner periphery-holding portion 90 abuts against a lower face of the aforementioned chucking area 12C of the disc medium 12. Accordingly, the first shutter 64 is disposed between the floor plate 38 and the disc medium 12 and can open and close a portion of the head aperture portion 16.

An outer periphery-holding protrusion portion 70 is provided so as to stand from an outer peripheral vicinity of the upper face of the first shutter 64, reaching the inner face of the annular wall portion 62. The outer periphery-holding protrusion portion 70 is set to substantially the same height as the first protrusion portion 68, and abuts against a region of a lower face of the disc medium 12 at a radial direction outer side relative to the recording surface 12B. Thus, the first shutter 64 has a structure which, when disposed at the closed position, supports the disc medium 12 from below at the first protrusion portion 68 and the outer periphery-holding protrusion portion 70.

A cam protrusion 72, which is oriented downward, is provided protruding from an outer peripheral vicinity of a lower face of the first shutter 64. The cam protrusion 72 is disposed at a radial direction outer side of the cutaway portion 65B, and is continuously inserted into a cam slot 78 (which is described later) of the second shutter 74.

The shutter mechanism 18 is provided with the second shutter 74, which serves as a shutter for closing off a remaining portion of the head aperture portion 16 (an inner peripheral side portion of the head aperture portion 16) when the first shutter 64 is disposed at the closed position. The second shutter 74 is formed in a flat plate form, and is disposed between the disc medium 12 (the recording surface 12B) and the floor plate 38 at a lower side relative to the first shutter 64 (the floor plate 38 side thereof).

Consequently, a portion of the first shutter 64 which interferes with a range of movement of the second shutter 74, which specifically is mainly a portion of the first shutter 64 at the radial direction outer side of the cutaway portion 65B, is made thinner than other portions of the first shutter 64. That is, the second shutter 74 is set to be thinner than a portion of the first shutter 64 which closes off the head aperture portion 16.

The second shutter 74 is formed in a long plate shape, and is provided with a boss portion 76 at a portion at one end in the length direction thereof. The boss portion 76 is rotatably supported at the support shaft 52 of the lower shell 26. Consequently, by rotation about the support shaft 52, the second shutter 74 can attain a closed position (see FIG. 8), which closes off the inner peripheral side portion of the head aperture portion 16, and an opened position (see FIG. 11), which is withdrawn from the head aperture portion 16.

As shown in FIGS. 1 and 8, in a state in which the first shutter 64 and the second shutter 74 are disposed at the respective closed positions thereof, mutually abutting end faces 64A and 74A thereof fit together and the first shutter 64 and second shutter 74 are a structure which completely closes the head aperture portion 16.

The abutting end face 74A is formed in a circular arc shape which has a radius of curvature which is centered on the axial center of the support shaft 52. Meanwhile, the abutting end face 64A is formed in a circular arc shape having a radius of curvature for abutting against the abutting end face 74A such that there is substantially no gap therebetween in the state in which the first shutter 64 and second shutter 74 are both disposed at the closed positions. As a result, it is possible for the second shutter 74 to rotate about the support shaft 52 without particular regard to a rotation position of the first shutter 64. Thus, the second shutter 74 is reliably prevented from interfering with the first shutter 64 in accordance with opening and closing of the head aperture portion 16, and can operate smoothly.

Thus, the first shutter 64 is structured to move from the closed position thereof toward the opened position by turning about the axial center of the inner rotor 60 in the direction of an arrow D in FIG. 8, and the second shutter 74 is structured to move from the closed position thereof toward the opened position by turning, relative to the head aperture portion 16, about the support shaft 52 in the direction of an arrow E, which is a direction substantially opposite to that of arrow D.

Further, the first shutter 64 and the second shutter 74 are coupled to one another. Specifically, the second shutter 74 is provided with the cam slot 78 substantially along the length direction thereof, and the cam protrusion 72 of the first shutter 64 is fitted into the cam slot 78.

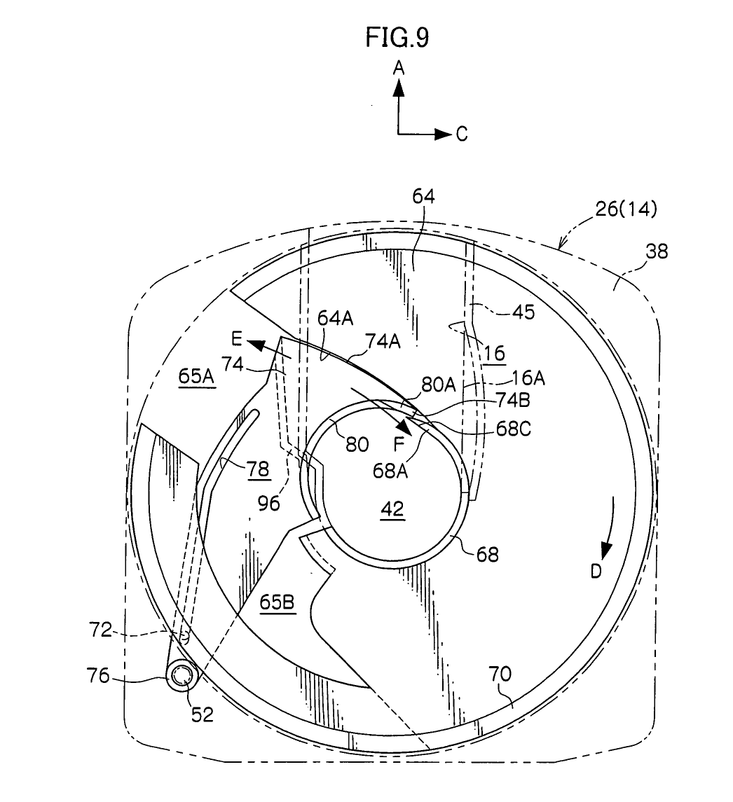

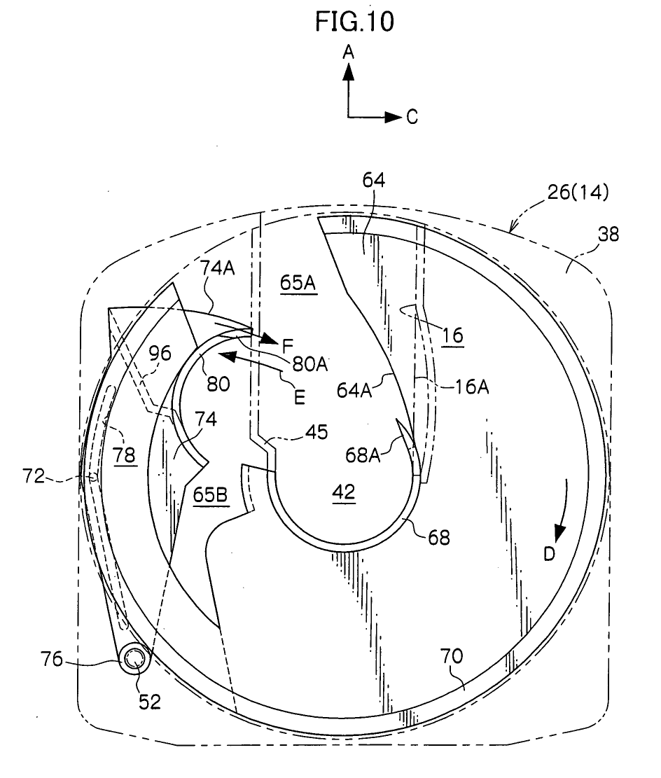

Accordingly, from the state in which the head aperture portion 16 is closed, when the operation protrusion 66 of the inner rotor 60 is moved rearward and the first shutter 64 rotates in the direction of arrow D, the cam protrusion 72, which is turning (orbiting) in the direction of arrow D, pushes against a slot wall of the cam slot 78 such that the second shutter 74 rotates in the direction of arrow E. In the state in which the head aperture portion 16 is closed, the cam protrusion 72 is disposed in a vicinity of the support shaft 52 side end portion of the cam slot 78. As shown in FIGS. 9 and 10, the cam protrusion 72 is a structure which moves so as to relatively separate from the support shaft 52 in accordance with turning of the inner rotor 60 in the direction of arrow D.

Hence, in the present embodiment, as shown in FIG. 10, the second shutter 74 reaches the opened position thereof earlier than the first shutter 64. In order to prevent subsequent rotation of the second shutter 74 in the direction of arrow E while assuring rotation of the first shutter 64 in the direction of arrow D, an end portion of the cam slot 78 at the opposite side thereof from the support shaft 52 side is formed in a circular arc shape which coincides with a path of movement of the cam protrusion 72 while the second shutter 74 is disposed at the opened position. As a result, the first shutter 64 can move from the position of turning shown in FIG. 10 to the opened position shown in FIG. 11 without interfering with the second shutter 74.

Further, the shutter mechanism 18 is a structure which returns from the state in which the head aperture portion 16 is opened to the state shown in FIG. 8 in which the head aperture portion 16 is closed, via the states shown in FIG. 10 and FIG. 9, by the inner rotor 60 turning in a direction opposite to arrow D.

As shown in FIGS. 1 and 2, the second protrusion portion 80, which is formed in a circular arc shape, is provided protruding from the upper face of the second shutter 74. In the state in which the head aperture portion 16 is closed, circumferential direction end portions of the second protrusion portion 80 fit together with corresponding circumferential direction end portions of the first protrusion portion 68, thus forming the annular disc inner periphery-holding portion 90.

An outer side (a radial direction inner side) of the second protrusion portion 80 of the second shutter 74 is formed as a cutaway portion 74B (see FIG. 2). Thus, in the state in which the first shutter 64 and the second shutter 74 are together disposed at the closed positions, a structure in which the chucking aperture portion 42 is completely open is formed. In other words, the chucking aperture portion 42 is a structure which is continuously opened up by the cutaway portions 65A and 74B, and which communicates with the disc aperture portion 20.

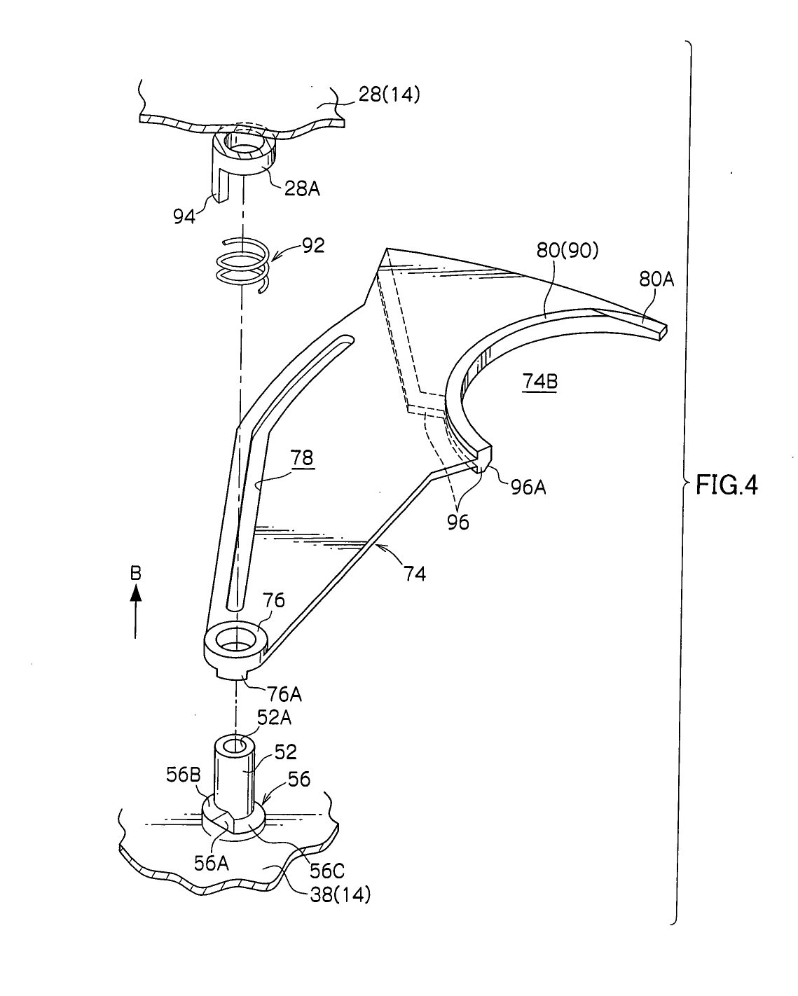

As is also shown in FIG. 4, a one end portion 80A of the second protrusion portion 80, at an abutting end face 74A side thereof, is formed in a tapering shape. In the present embodiment, the one end portion 80A is formed as an inflected surface which faces to each of the upper side, a circumferential direction distal end side, and a radial direction inner side. A one end portion 68A of the first protrusion portion 68, which fits together with the one end portion 80A of the second protrusion portion 80, is formed as a tapering surface to correspond with the one end portion 80A. Thus, a structure is formed in which, in the state in which the head aperture portion 16 is closed, there is little likelihood of a gap occurring in the disc inner periphery-holding portion 90, which is formed in the annular shape by fitting together the circumferential direction end portions of the first protrusion portion 68 and the second protrusion portion 80.

The disc inner periphery-holding portion 90, which is formed in the annular shape by the first protrusion portion 68 and the second protrusion portion 80 in the state in which the head aperture portion 16 is closed, is a structure whose upper end face abuts against the chucking area 12C of the lower face of the disc medium 12 from below (to support the disc medium 12 from below). Consequently, a structure is formed such that dust and the like will not ingress through the chucking aperture portion 42, which is always open, to the lower face of the disc medium 12, that is, to the recording surface 12B side of the disc medium 12.

The disc cartridge 10 is provided with a second shutter-raising/lowering mechanism, which raises and lowers the second shutter 74 such that the second protrusion portion 80 will not be caused to interfere with the recording surface 12B of the disc medium 12 during opening and closing of the head aperture portion 16. This second shutter-raising/lowering mechanism will be described later.

The shutter mechanism 18 is further provided with the disc-holding member 82, and the disc-holding member 82 is provided with a disc outer periphery-holding portion 82A. In the state in which the first shutter 64 and the second shutter 74 close off the head aperture portion 16, the disc outer periphery-holding portion 82A bridges across between circumferential direction end portions of the outer periphery-holding protrusion portion 70, which is cut away at the radial direction outer end of the cutaway portion 65A of the first shutter 64.

That is, the disc outer periphery-holding portion 82A is a structure which, together with the outer periphery-holding protrusion portion 70 of the first shutter 64 that is disposed at the closed position, forms an annular shape. In this state, an upper face of the disc outer periphery-holding portion 82A is substantially coplanar with an upper face of the outer periphery-holding protrusion portion 70, and abuts against a remaining portion of a region of the lower face of the disc medium 12 that is at the radial direction outer side relative to the recording surface 12B (to support the disc medium 12 from the lower side).

Thus, a structure is formed such that dust and the like will not ingress through the disc aperture portion 20 to the lower face of the disc medium 12, that is, to the recording surface 12B side of the disc medium 12.

This disc-holding member 82 is supported by the pair of guide pins 58 of the lower shell 26 to be vertically movable. The disc-holding member 82 is formed as a structure which descends in accordance with the operation of turning of the inner rotor 60 in the direction of arrow D, and does not interfere with the outer periphery-holding protrusion portion 70 that is turning in the direction of arrow D. Details are not given herein, but corresponding circumferential direction end portions of the disc outer periphery-holding portion 82A and the outer periphery-holding protrusion portion 70 are formed in tapering shapes which are vertically superposed, forming a structure in which the disc outer periphery-holding portion 82A is caused to subside to the lower side of the outer periphery-holding protrusion portion 70 by the rotation of the inner rotor 60 in the direction of arrow D.

Further, in a process of transition from the opened state to the closed state of the head aperture portion 16, an operation opposite to that described above is carried out.

Structure of Disc Retention Mechanism

The disc retention mechanism 22 is equipped with the disc-constraining member 84. The disc-constraining member 84 has a structure which is provided with a pair of support shaft portions 84A and an arm portion 84B. The support shaft portions 84A are respectively rotatably supported at the pair of bearing portions 54 of the lower shell 26. The arm portion 84B is formed integrally with the pair of support shaft portions 84A and is long in the left-right direction.

A pair of left and right disc-abutting portions 84C is provided at the arm portion 84B. The disc-abutting portions 84C abut against the upper face of the disc medium 12. The disc-abutting portions 84C may be structured of rubber or the like as separate members from the support shaft portions 84A and the arm portion 84B, which are integrally formed of a resin material or the like.

The disc-constraining member 84 is structured to be capable, by rotation about the support shaft portions 84A, of selectively attaining a disc-constraining position, a disc rotation-allowing position and a disc installation/uninstallation-allowing position. At the disc-constraining position, the arm portion 84B is projected over the interior of the disc accommodation portion 50 (the disc aperture portion 20) and the disc-abutting portions 84C are caused to abut against the upper face of the disc medium 12. At the disc rotation-allowing position, the arm portion 84B is projected over the interior of the disc accommodation portion 50 but the disc-abutting portions 84C are separated from the upper face of the disc medium 12. At the disc installation/uninstallation-allowing position, the arm portion 84B is withdrawn from the disc accommodation portion 50.

As shown in FIG. 2, the disc retention mechanism 22 is further equipped with a disc-constraint spring 86 and the locking member 88. The disc-constraint spring 86 urges the disc-constraining member 84 toward the disc-constraining position. The locking member 88 is provided in the case 14 to be capable only of sliding in the left-right direction and exposes an operation protrusion 88A thereof through the lock operation window 36. The disc-constraint spring 86 is formed as a torsion coil spring, one end portion of which engages with the arm portion 84B and the other end portion of which engages with an engaging protrusion 88B of the locking member 88. Thus, the disc-constraining member 84 is a structure which is ordinarily disposed at the disc-constraining position by an urging force of the disc-constraint spring 86 and which retains the disc medium 12.

This disc-constraining member 84 moves from the disc-constraining position to the disc rotation-allowing position in accordance with the operation of the first shutter 64 for opening the head aperture portion 16. Specifically, the annular wall portion 62 of the inner rotor 60 is provided with a portion whose wall height is higher than at other portions of the annular wall portion 62 (not shown in the drawings). In accordance with rotation of the inner rotor 60 in the direction of arrow D, this portion of the annular wall portion 62 lifts up the arm portion 84B in the cutaway portions 34. Thus, this structure moves the disc-constraining member 84 from the disc-constraining position to the disc rotation-allowing position.

Hence, in the state in which the head aperture portion 16 is opened, a state in which the disc-constraining member 84 is disposed at the disc rotation-allowing position is maintained. As a result, with this structure, the disc-constraining member 84 is prevented from interfering with the rotating disc medium 12.

Moreover, when the operation protrusion 88A is disposed at a left end of the lock operation window 36, the locking member 88 engages with the other end portion of the disc-constraint spring 86. However, when the operation protrusion 88A is disposed at a right end of the lock operation window 36, the engagement of the locking member 88 with the other end portion of the disc-constraint spring 86 is released. Therefore, when the operation protrusion 88A is operated and the locking member 88 is moved to the right, the urging force of the disc-constraint spring 86 does not act on the disc-constraining member 84. In this state, if the disc-constraining member 84 is moved to the disc installation/uninstallation-allowing position by hand, the disc-constraining member 84 will not return to the disc-constraining position even if released by the hand. Thus, with this structure, insertion of the disc medium 12 into the disc accommodation portion 50, extraction (removal) of the same, and replacement, etc. can be carried out with ease.

Structure of Second Shutter-Raising/Lowering Mechanism

As shown in FIG. 4, the cam portion 56, which is formed in an annular shape in plan view, is provided protruding from the base portion of the support shaft 52 at the floor plate 38 of the case 14, concentrically with the support shaft 52. A higher surface portion 56B and a lower surface portion 56C, which have different height levels, are formed at an upper face of the cam portion 56. A taper surface 56A, which is a step portion provided at a circumferential direction portion of the cam portion 56, defines a boundary between the higher surface portion 56B and the lower surface portion 56C.

That is, the upper face of the cam portion 56 is structured by circumferential direction end portions of the higher surface portion 56B and lower surface portion 56C, which have mutually different height positions, being connected by the taper surface 56A. A height difference between the higher surface portion 56B and the lower surface portion 56C is set to around 0.3 to 0.5 mm (and is exaggeratedly shown in the drawings).

The boss portion 76 of the second shutter 74 fits with play at the support shaft 52, and the second shutter 74 is made capable of movement in an axial direction of the support shaft 52. That is, the second shutter 74 is made movable toward and away from the recording surface 12B of the disc medium 12 in an axial direction (plate thickness direction) of the disc medium 12. A sliding protrusion 76A, which serves as a follower, is provided protruding downward from a circumferential direction portion of the boss portion 76 of the second shutter 74.

In accordance with the operation in which the second shutter 74 turns about the support shaft 52, the sliding protrusion 76A slides against the upper face of the cam portion 56. The sliding protrusion 76A is provided so as to abut against the higher surface portion 56B when the second shutter 74 is disposed at the closed position, and when the second shutter 74 rotates by a small amount in the direction of arrow E from the closed position, the sliding protrusion 76A slides against the taper surface 56A and the lower surface portion 56C, in that order, and promptly descends.

Further, when the second shutter 74 is disposed at the opened position, the sliding protrusion 76A abuts against the lower surface portion 56C of the cam portion 56. Then, when the second shutter 74 turns from the opened position in the direction of arrow F, which is opposite to arrow E, the sliding protrusion 76A slides against the taper surface 56A and moves away from the lower surface portion 56C toward the higher surface portion 56B.

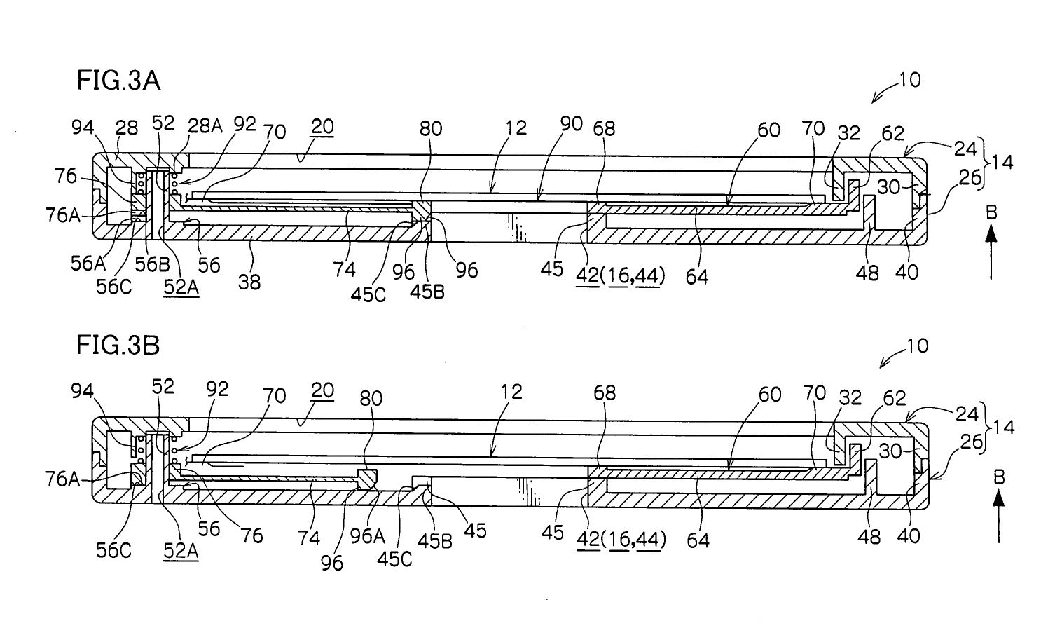

With the structure described above, in the state in which the second shutter 74 is disposed at the closed position for closing the head aperture portion 16, as shown in FIG. 3A, the sliding protrusion 76A is abutted against the higher surface portion 56B and is in a state of closest approach to the disc medium 12 (i.e., is disposed at a near position). In this state, the second protrusion portion 80 provided at the second shutter 74 coincides in upper face height level with the first protrusion portion 68 of the first shutter 64, and abuts against the chucking area 12C of the disc medium 12. In other words, in this state the second protrusion portion 80 structures the disc inner periphery-holding portion 90.

On the other hand, in a process in which the second shutter 74 is opening or closing the head aperture portion 16 or a state in which the head aperture portion 16 is completely opened, as shown in FIG. 3B, the sliding protrusion 76A is slid or abutted against the lower surface portion 56C, and is in a state of being disposed at a position which is separated further from the disc medium 12 than the above-mentioned near position. Thus, with this structure, in the processes of opening and closing the head aperture portion 16 and the state in which the head aperture portion 16 is fully opened, the second protrusion portion 80 is separated from the recording surface 12B of the disc medium 12, and will not interfere with the recording surface 12B.

Herein, in these states, the first shutter 64 supports the disc medium 12 from below with the first protrusion portion 68 and the outer periphery-holding protrusion portion 70, and serves as a structure for maintaining the disc medium 12 in a state of being substantially parallel with the floor plate 38.

Thus, the cam portion 56 and the sliding protrusion 76A structure a guide mechanism of the present invention. Note that the cam portion 56 could include a plurality of each of the taper surface 56A, the higher surface portion 56B and the lower surface portion 56C along the circumferential direction, with the second shutter 74 including a corresponding plurality of the sliding protrusion 76A.

The second shutter-raising/lowering mechanism is further provided with a pressure spring 92, which serves as an urging member. The pressure spring 92 is formed as a compression coil spring in the present embodiment, and is disposed around the support shaft 52. The pressure spring 92 is provided in a compressed state between an upper face of the boss portion 76 and a spring-holding portion 28A, which is provided protruding from the ceiling plate 28 of the case 14. Thus, a structure is formed in which the second shutter 74 is continuously urged downward by urging force of the pressure spring 92 and the sliding protrusion 76A is pressed against the cam portion 56.

A stopper protrusion 94 is provided protruding from the ceiling plate 28 to serve as a stopper. When the second shutter 74 is disposed at the closed position, that is, in the state in which the second shutter 74 is closest to the disc medium 12, the stopper protrusion 94 abuts against the upper face of the boss portion 76. Thus, a structure is formed in which the second shutter 74 that is disposed at the closed position is prevented from moving upward. The stopper protrusion 94 is disposed so as to abut against a portion of the upper face of the boss portion 76 that is directly above the sliding protrusion 76A (at a position of abutting against the higher surface portion 56B).

Here, the stopper protrusion 94 may, for example, be provided integrally with a spring-holding member which is formed as a separate body from the ceiling plate 28 and fixed to an upper end of the support shaft 52.

Anyway, in this disc cartridge 10, as shown in FIG. 3A, a gap is formed between the floor plate 38 and the second shutter 74 in order to permit downward movement of the second shutter 74 from the state in which the head aperture portion 16 is closed. In order to prevent ingression of dust or the like through this gap into the disc accommodation portion 50 of the case 14 (to the recording surface 12B of the disc medium 12), the case-side dust protection rib 45 is provided protruding from the upper face of the floor plate 38 of the case 14.

As shown in FIG. 2, the case-side dust protection rib 45 is provided along an edge portion of the access aperture 44, and a portion of the case-side dust protection rib 45 is located to a right side relative to a right edge 16A side of the head aperture portion 16. This portion serves as a circular arc portion 45A, which is formed in a circular arc shape to correspond with the abutting end face 64A of the first shutter 64. Thus, access aperture 44 side edge portions of the case-side dust protection rib 45 are formed to correspond with edge portions of the cutaway portion 65A of the first shutter 64 (with a boundary portion between the cutaway portion 65A and the cutaway portion 65B being assumed to have a linear form).

A portion of the case-side dust protection rib 45 which the second shutter 74 that is disposed at the closed position traverses serves as a low portion 45B, which is at a lower level than other portions of the case-side dust protection rib 45. This low portion 45B is structured such that a height level thereof with respect to the floor plate 38 causes a downward shift of the second shutter 74. Therefore, the height position of the low portion 45B relative to the floor plate 38 corresponds to the height difference between the higher surface portion 56B and the lower surface portion 56C of the cam portion 56.

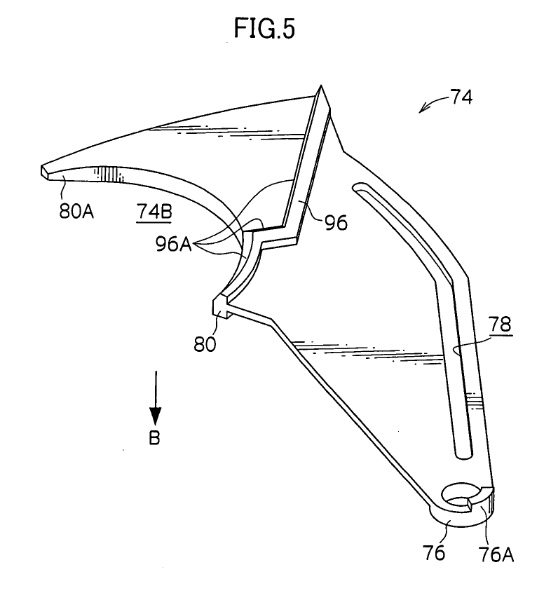

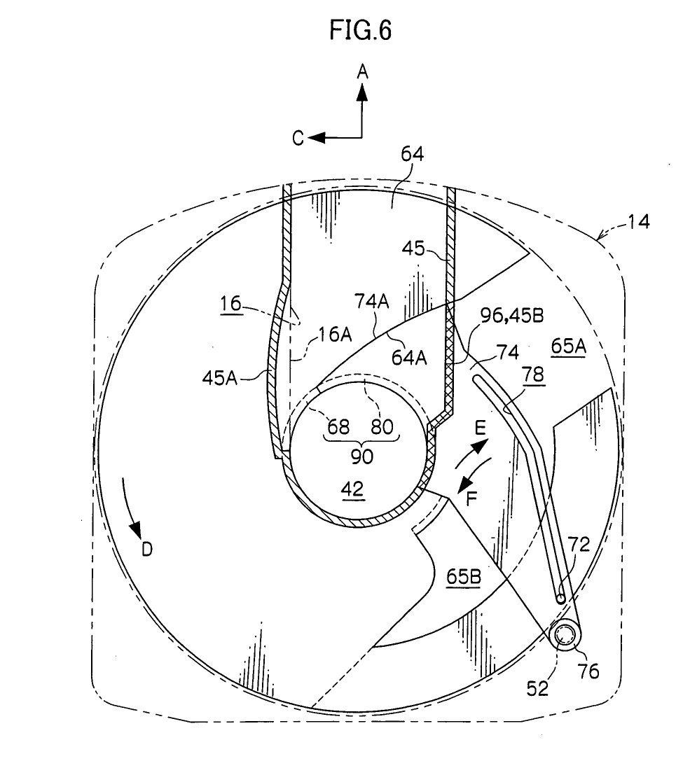

Further, as shown in FIG. 5, a shutter-side dust protection rib 96 is provided protruding from the lower face of the second shutter 74 with a form which corresponds with the low portion 45B of the case-side dust protection rib 45. A protrusion height of the shutter-side dust protection rib 96 corresponds with the height difference between the low portion 45B of the case-side dust protection rib 45 and other portions of the case-side dust protection rib 45. Consequently, as shown in FIG. 6, in the state in which the second shutter 74 is disposed at the closed position, the shutter-side dust protection rib 96 is disposed on the low portion 45B and a gap above the low portion 45B is closed off.

The protrusion height of the shutter-side dust protection rib 96 is equal to or slightly larger than the height level of the low portion 45B with respect to the floor plate 38. With this structure, the abutting end face 74A of the second shutter 74 does not interfere with the low portion 45B in the state in which the second shutter 74 is disposed at the opened position, as shown in FIG. 7.

As shown in FIG. 4, a face of the shutter-side dust protection rib 96 at the side thereof that approaches the low portion 45B when the head aperture portion 16 is being closed is formed as a taper surface 96A. The taper surface 96A rides up on the low portion 45B in accordance with the operation of rotation of the second shutter 74 in the direction of arrow F.

Meanwhile, as shown in FIGS. 3A and 3B, a right side face of the low portion 45B of the case-side dust protection rib 45 is formed as a taper surface 45C, which corresponds with the taper surface 96A. In other words, the low portion 45B is structured with an upper end portion thereof being narrower, and when the second shutter 74 that is disposed at the closed position turns a little in the direction of arrow E (for example, to the state shown in FIG. 9), the second shutter 74 promptly descends.

Because the case-side dust protection rib 45 is provided along the access aperture 44, the first shutter 64 slides on the case-side dust protection rib 45 in accordance with opening and closing of the head aperture portion 16. As a result, an increase in plate thickness of the first shutter 64 is avoided, and sliding resistance between the first shutter 64 and the case 14 is reduced.

Herein, in order to keep the attitude of the first shutter 64 stable, a protrusion which slides against the floor plate 38 may be provided protruding from the first shutter 64 and/or a protrusion which slides against the first shutter 64 may be provided protruding from the floor plate 38. Furthermore, rather than providing the circular arc portion 45A, the case-side dust protection rib 45 may simply be formed along the access aperture 44.

Next, operations of the present embodiment will be described.

In the disc cartridge 10 described above, at times of non-use, such as during storage, during distribution and the like, the first shutter 64 and the second shutter 74 are disposed at their respective closed positions and the head aperture portion 16 is closed. Meanwhile, the disc-constraining member 84 presses downward on the disc medium 12 with the urging force of the disc-constraint spring 86 and prevents looseness of the disc medium 12.

The first protrusion portion 68 and the second protrusion portion 80 form the annular disc inner periphery-holding portion 90 and the upper end face of this disc inner periphery-holding portion 90 abuts against the chucking area 12C of the disc medium 12.

The outer periphery-holding protrusion portion 70 and the disc outer periphery-holding portion 82A of the disc-holding member 82 form an annular shape and abut against the region of the disc medium 12 at the radial direction outer side relative to the recording surface 12B.

The lower face of the first shutter 64 abuts against the case-side dust protection rib 45, and the shutter-side dust protection rib 96 of the second shutter 74 is raised up on the low portion 45B of the case-side dust protection rib 45.

In accordance with these conditions, ingression of dust and the like from the inner peripheral side of the disc medium 12 toward the recording surface 12B and ingression of dust and the like from the outer peripheral side of the disc medium 12 toward the recording surface 12B are prevented, and contact of the recording surface 12B of the disc medium 12 with the first shutter 64 and the second shutter 74 is prevented.

When this disc cartridge 10 is to be employed, that is, when information is to be recorded at the disc medium 12 and when information recorded at the disc medium 12 is to be replayed, the disc cartridge 10 is loaded into a drive device in the direction of arrow A. In accordance with this loading operation (i.e., relative movement between the disc cartridge 10 and the drive device), an opening/closing member of the drive device engages with the operation protrusion 66 of the inner rotor 60 and moves the operation protrusion 66 rearward.

Accordingly, the inner rotor 60, which is to say the first shutter 64, turns in the direction of arrow D, and the second shutter 74 turns in the direction of arrow E interlockingly therewith. At an initial stage of this rotation of the second shutter 74 in the direction of arrow E, in accordance with the rotation, the shutter-side dust protection rib 96 is withdrawn from on the low portion 45B of the case-side dust protection rib 45 and the sliding protrusion 76A moves from on the higher surface portion 56B of the cam portion 56 to the lower surface portion 56C, via the taper surface 56A. Accordingly, the second shutter 74 subsides because of the urging force of the pressure spring 92 (and gravity), and the second protrusion portion 80 moves away from the lower face of the disc medium 12.

When the first shutter 64 turns further in the direction of arrow D and the second shutter 74 turns further in the direction of arrow E, and the operation protrusion 66 moves to a rear end of the shutter operation window 46 via the states shown in FIGS. 9 and 10, the state in which the head aperture portion 16 is fully opened as shown in FIG. 11 is attained. In this process of opening the head aperture portion 16 and in the state in which the head aperture portion 16 is fully opened, the second shutter 74, together with the second protrusion portion 80, is separated from the disc medium 12. Therefore, the second protrusion portion 80 does not interfere with the recording surface 12B of the disc medium 12.

Next, the disc cartridge 10 is positioned in the drive device by insertion of positioning pins into the reference holes 52A and 53A of the floor plate 38, or the like. In this positioned state, a rotating spindle shaft of the drive device advances in through the chucking aperture portion 42. The rotating spindle shaft chucks the center hole 12A (and the chucking area 12C) of the disc medium 12 and, while retaining the disc medium 12, moves the disc medium 12 away from the first protrusion portion 68 of the first shutter 64 and the outer periphery-holding protrusion portion 70. Then, when the rotating spindle shaft is rotated, the disc medium 12 is driven to rotate inside the case 14 in a state of non-contact therewith.

Meanwhile, a recording/playback head of the drive device advances in through the head aperture portion 16.

Information is recorded at the recording surface 12B of the disc medium 12 and/or information that has been recorded at the recording surface 12B is replayed by this recording/playback head (i.e., the disc medium 12 is used).

After use of the disc medium 12, in a state in which the disc medium 12 has been placed on the first protrusion portion 68 of the first shutter 64 and the outer periphery-holding protrusion portion 70, the disc cartridge 10 is ejected from the drive device. In accordance with this ejection operation, the opening/closing member of the drive device engages with the operation protrusion 66 of the inner rotor 60 and moves the operation protrusion 66 forward. Accordingly, the inner rotor 60, which is to say the first shutter 64, turns in the direction opposite to arrow D, and the second shutter 74 turns in the direction of arrow F interlockingly therewith.

At this time, because the second shutter 74, together with the second protrusion portion 80, is separated from the lower face of the disc medium 12, the second protrusion portion 80 does not interfere with the recording surface 12B of the disc medium 12.

Then, when the second protrusion portion 80 reaches the radial direction inner side relative to the recording surface 12B, in accordance with the rotation of the second shutter 74 in the direction of arrow F, the sliding protrusion 76A slides against the taper surface 56A, moving from the lower surface portion 56C to the higher surface portion 56B, and at the same time, the shutter-side dust protection rib 96 slides the taper surface 96A against the taper surface 45C and the taper surface 96A rides up on the low portion 45B of the case-side dust protection rib 45.

Correspondingly, the second shutter 74 ascends with the second protrusion portion 80, and the upper end face of the second protrusion portion 80 abuts against the chucking area 12C of the disc medium 12. That is, the second shutter 74 returns to the near position with respect to the disc medium 12 in the vertical direction.

When the disc cartridge 10 returns to the state in which the head aperture portion 16 is fully closed as shown in FIG. 8, the second protrusion portion 80, together with the first protrusion portion 68, structures the annular-form disc inner periphery-holding portion 90, and the disc cartridge 10 returns to the state in which the chucking area 12C of the disc medium 12 is supported and ingression of dust or the like to the recording surface 12B side is prevented. In other words, the disc cartridge 10 returns to the state prior to employment.

Now, in the process of opening or closing the head aperture portion 16 and the state in which the head aperture portion 16 is fully opened, because the second shutter 74 subsides and moves away from the disc medium 12, the second protrusion portion 80 provided at the second shutter 74 is prevented from making contact with the recording surface 12B of the disc medium 12.

Further, in the state in which the head aperture portion 16 is opened, the disc medium 12 abuts against the first protrusion portion 68 of the first shutter 64 and the outer periphery-holding protrusion portion 70 and is maintained in a state of being substantially level with respect to the floor plate 38 of the case 14 (and a reference surface for positioning with respect to the drive device). Consequently, retention of the disc medium 12 by the rotating spindle shaft of the drive device is performed accurately and easily, and surface runout during rotation of the disc medium 12 is avoided.

Thus, with the disc cartridge 10 relating to the present embodiment, interference of the second protrusion portion 80 for dustproofing which is provided at the second shutter 74 with the recording surface 12B of the disc medium 12 can be reliably prevented.

In particular, because the pressure spring 92 which urges the second shutter 74 downward is provided, the second shutter 74 can be moved toward the floor plate 38 and separated from the disc medium 12 without any reliance on gravity. Further, looseness of the second shutter 74, whose sliding protrusion 76A slides or abuts against the upper surface of the cam portion 56, is prevented, and attitudes and operations of the second shutter 74 are stable.

Therefore, even in a case in which, for example, the disc cartridge 10 is loaded in a vertical-type drive device in which the axis of the disc medium 12 is arranged to be aligned with a horizontal plane, the second protrusion portion 80 can implement the functions described above without interfering with the recording surface 12B.

Furthermore, because the stopper protrusion 94 which limits raising of the second shutter 74 that is disposed at the closed position is provided, the second protrusion portion 80 provided at the second shutter 74 which can be raised and lowered (vertically moved) is prevented from protruding to the upper side relative to the first protrusion portion 68, and action of an undesired load on the disc medium 12 that is retained by the disc-constraining member 84 is prevented. Therefore, even if, for example, the second shutter 74 is pressed from outside due to carelessness or mishandling by a user, the disc medium 12 will be protected.

Further still, the second shutter-raising/lowering mechanism which raises and lowers the second shutter 74 is provided between the portion of the case 14 around the support shaft 52, which is disposed at the radial direction outer side of the disc accommodation portion 50 (and the disc medium 12), and the boss portion 76 of the second shutter 74. In other words, the second shutter-raising/lowering mechanism for moving the second shutter 74 in the thickness direction of the case 14 is disposed at the outer side of the disc medium 12. Consequently, it is possible to efficiently utilize limited space in the case 14 (i.e., to utilize a relatively wide space vertically between the ceiling plate 28 and the floor plate 38) to provide the second shutter-raising/lowering mechanism.

Further, because the second shutter-raising/lowering mechanism is structured to include the cam portion 56, which is provided at the floor plate 38 around the base portion of the support shaft 52, and the sliding protrusion 76A, which is provided protruding from the boss portion 76 of the second shutter 74, the function of the second protrusion portion 80 not interfering with the recording surface 12B is implemented with a simple structure. Moreover, it is possible with this structure to employ the aforementioned pressure spring 92, which is an easily assembled compression coil spring, to serve as the urging member.

Now, the embodiment described above has a preferable structure in which the second shutter-raising/lowering mechanism is provided around the axis of rotation of the second shutter 74. However, the present invention is not limited thus. For example, the second shutter-raising/lowering mechanism may be structured by providing a rib at a lower face of the second shutter 74, which rib is raised and lowered at a rib provided at the floor plate 38 interlockingly with the operation in which the shutter-side dust protection rib 96 is raised and lowered at the low portion 45B of the case-side dust protection rib 45.

Alternatively, a structure is possible in which a rib is provided at the upper face of the second shutter 74, and this rib raises and lowers a rib provided at the lower face of the first shutter 64 interlockingly with the operation in which the shutter-side dust protection rib 96 is raised and lowered at the low portion 45B of the case-side dust protection rib 45.

As a further example, in a structure in which the second shutter-raising/lowering mechanism is provided around the center of rotation of the second shutter 74, it is possible to provide the cam portion 56 to be oriented downward at the boss portion 76 and to protrude the sliding protrusion 76A from the upper face of the floor plate 38.

Further, the embodiment described above has a structure which is provided with the pressure spring 92, which is a compression coil spring, to serve as the urging member. However, the present invention is not limited thus. For example, structures in which the urging member is not provided are possible. It is also possible to employ another resilient member, such as a plate spring or the like, as the urging member. In a case in which the urging member is not provided, it is possible, for example, for the cam portion 56 and the sliding protrusion 76A to structure a positive motion cam.

Further again, the embodiment described above has a structure in which the stopper protrusion 94 is provided to serve as a stopper which limits raising of the second shutter 74. However, the present invention is not limited thus. Structures in which the stopper protrusion 94 is not provided are also possible.

In such a case, and in the embodiment described above, the first shutter 64 provided above the second shutter 74 also functions as the stopper. In particular, because the one end portion 80A of the second protrusion portion 80 matches up with the one end portion 68A of the first protrusion portion 68 from the lower side thereof, raising of the second shutter 74 can be effectively blocked.

Further yet, the embodiment described above exemplifies a structure in which the disc aperture portion 20 is formed in the case 14. However, the present invention is not limited thus. For example, a structure in which an aperture portion is not formed in the ceiling plate 28 is possible, and a structure in which the head aperture portion 16 or the access aperture 44 is also formed in the ceiling plate 28, instead of the disc aperture portion 20, is also possible. In the latter case, the shutter mechanism 18 or a different shutter mechanism can be provided between the ceiling plate 28 and the disc medium 12.

Further still, the embodiment described above has a structure in which the chucking aperture portion 42 is always open. However, the present invention is not limited thus, and a structure in which the chucking aperture portion 42 is closed off together with the head aperture portion 16 by the first shutter 64 and the second shutter 74 is also possible. However, the present invention is excellently applied to structures in which the disc aperture portion 20 is provided and/or the chucking aperture portion 42 is always open.

Further still again, although the embodiment described above has a structure in which the diameter of the disc medium 12 is approximately 120 mm, the present invention is not limited thus. Obviously, the present invention can be applied to the disc cartridge 10 that is provided with the disc medium 12 with any dimension. Furthermore, for example, the disc medium 12 may be a double-sided recording-type medium as well as a single-sided recording-type medium and, obviously, may be a read-only disc medium at which recording of information by a user is not possible.

Accordingly, the recording/playback head of the above-mentioned drive device may be a head which only has recording functions or which only has playback functions.

Further yet again, the disc cartridge 10 of the present invention is not limited to a cartridge of which the disc medium 12 is a major structural element. For example, a cartridge at which the disc medium 12 is accommodated only when the disc medium 12 is to be used is also possible.

1. A disc cartridge comprising:
a case rotatably accommodating a circular plate-form disc medium, the case including a head aperture portion for enabling access to a recording surface of the disc medium;
a first shutter provided in the case at the recording surface side of the disc medium, the first shutter turning coaxially with an axial center of the disc medium for opening and closing a portion of the head aperture portion;
a second shutter provided in the case at the recording surface side of the disc medium to be movable toward and away from the disc medium, the second shutter turning about a different axis from the first shutter for opening and closing a remaining portion of the head aperture portion;
a first protrusion portion provided at the first shutter and formed in a circular arc shape, the first protrusion portion abutting against the disc medium at an inner side relative to the recording surface;
a second protrusion portion provided at the second shutter and formed in a circular arc shape, the second protrusion portion and the first aperture portion provided at the first shutter together forming an annular shape in a state in which the head aperture portion is closed; and
a guide mechanism which, in the state in which the head aperture portion is closed, retains the second shutter at a position near to the disc medium, at which near position the second protrusion portion, together with the first protrusion portion, abuts against the disc medium at the inner side relative to the recording surface, and which, in processes of opening and closing the head aperture portion and in a state in which the head aperture portion is opened, displaces the second shutter to be separated further from the disc medium than the near position.

2. The disc cartridge of claim 1, wherein the case comprises a support shaft provided at a radial direction outer side relative to the disc medium,
the second shutter includes a boss portion which is fitted to the support shaft, the second shutter being supported to be rotatable with respect to the support shaft and movable in an axial direction of the support shaft, and
the guide mechanism is provided between the boss portion and a portion of the case around the support shaft.

3. The disc cartridge of claim 2, wherein the guide mechanism comprises: a cam portion, which is provided at the case around a base portion of the support shaft and forms a taper-form step in a circumferential direction of the support shaft; and a follower, which is provided protruding from the support shaft base portion side of the boss portion and which slides against a cam surface in accordance with opening and closing of the head aperture portion.

4. The disc cartridge of claim 1, further comprising an urging member which urges the second shutter in a direction away from the disc medium.

5. The disc cartridge of claim 1, further comprising a stopper which limits movement of the second shutter such that the second protrusion portion does not protrude further toward the recording surface of the disc medium than the first protrusion portion.

6. The disc cartridge of claim 1, wherein the first protrusion portion limits movement of the second shutter such that the second protrusion portion does not protrude further toward the recording surface of the disc medium than the first protrusion portion.

7. The disc cartridge of claim 1, wherein, when the second shutter is at the near position, vertical direction positions of an upper face of the first protrusion portion and an upper face of the second protrusion portion coincide.

8. The disc cartridge of claim 1, further comprising a shutter-side dust protection rib which protrudes from a lower face of the second shutter.

9. The disc cartridge of claim 8, further comprising a case-side dust protection rib which is provided at the case and which, when the second shutter is at the near position, corresponds with a position of the shutter-side dust protection rib.

10. The disc cartridge of claim 9, wherein, when the second shutter is at the near position, the shutter-side dust protection rib is raised up on and abuts against the case-side dust protection rib.

11. The disc cartridge of claim 10, wherein, when the shutter-side dust protection rib is raised up on and abutted against the case-side dust protection rib at the near position, vertical direction positions of an upper face of the first protrusion portion and an upper face of the second protrusion portion coincide.

12. The disc cartridge of claim 3, wherein the cam portion comprises a higher surface portion and a lower surface portion, the follower abuts against the higher surface portion when the second shutter is at the near position and, when the second shutter turns from the near position by a small amount in a direction for opening the head aperture portion, the follower slides to the lower surface portion and promptly descends.

13. A disc cartridge comprising:
a case rotatably accommodating a circular plate-form disc medium, the case including a head aperture portion for enabling access to a recording surface of the disc medium;
a first shutter provided in the case at the recording surface side of the disc medium, the first shutter turning coaxially with an axial center of the disc medium for opening and closing a portion of the head aperture portion;
a second shutter provided in the case at the recording surface side of the disc medium to be movable toward and away from the disc medium, the second shutter turning about a different axis from the first shutter for opening and closing a remaining portion of the head aperture portion;
a first protrusion portion provided in a circular arc shape at the recording surface side of the first shutter;
a second protrusion portion provided in a circular arc shape at the recording surface side of the second shutter, the second protrusion portion forming an annular shape with the first protrusion portion; and
a guide mechanism which, in a state in which the head aperture portion is closed, retains the second shutter at a first position, at which vertical direction positions of an upper face of the second protrusion portion and an upper face of the first protrusion portion coincide and the two protrusion portions form the annular shape and abut against the recording surface of the disc medium, and which, in processes of opening and closing the head aperture portion and in a state in which the head aperture portion is opened, retains the second shutter at a second position, which is separated further from the disc medium than the first position.

14. The disc cartridge of claim 13, further comprising:
a shutter-side dust protection rib which protrudes from a lower face of the second shutter; and
a case-side dust protection rib which is provided at the case and which, when the second shutter is at the first position, corresponds with a position of the shutter-side dust protection rib.

15. The disc cartridge of claim 14, wherein, when the second shutter is at the first position, the shutter-side dust protection rib is raised up on and abuts against the case-side dust protection rib.

16. The disc cartridge of claim 13, wherein the case comprises a support shaft provided at a radial direction outer side relative to the disc medium,
the second shutter includes a boss portion which is fitted to the support shaft, the second shutter being supported to be rotatable with respect to the support shaft and movable in an axial direction of the support shaft, and
the guide mechanism is provided between the boss portion and a portion of the case around the support shaft.

17. The disc cartridge of claim 16, wherein the guide mechanism comprises: a cam portion, which is provided at the case around a base portion of the support shaft and forms a taper-form step in a circumferential direction of the support shaft; and a follower, which is provided protruding from the support shaft base portion side of the boss portion and which slides against a cam surface in accordance with opening and closing of the head aperture portion.

18. The disc cartridge of claim 13, further comprising an urging member which urges the second shutter in a direction away from the disc medium.

19. The disc cartridge of claim 13, further comprising a stopper which limits movement of the second shutter such that the second protrusion portion does not protrude further toward the recording surface of the disc medium than the first protrusion portion.

20. The disc cartridge of claim 13, wherein the first protrusion portion limits movement of the second shutter such that the second protrusion portion does not protrude further toward the recording surface of the disc medium than the first protrusion portion.
